(19) United States
(12) Patent Application Publication
(10) Pub. No.: US 2010/0216454 A1
(43) Pub. Date: Aug. 26, 2010

(54) RADIO TRANSMISSION DEVICE, RADIO RECEPTION DEVICE, CELL SWITCHING METHOD, AND RADIO COMMUNICATION SYSTEM

(75) Inventors: Chie Ishida, Kanagawa (JP); Takahisa Aoyama, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/680,642

(22) PCT Filed: Sep. 30, 2008
(86) PCT No.: PCT/JP2008/002733

§ 371 Date: Mar. 29, 2010

(30) Foreign Application Priority Data
Oct. 1, 2007 (JP) 2007-257763

(51) Int. Cl. H04W 24/00

(52) U.S. Cl. 455/424

(57) ABSTRACT

It is possible to provide a radio transmission device, a radio reception device, and a radio communication system which can effectively use a resource of a unicast/MBMS cell and prevent increase of a signaling amount accompanying a cell switching. A UE measures a reception level of an MEMS-dedicated cell. When the measured reception level is below a first threshold value, the UE switches the serving MBMS cell from the MBMS-dedicated cell to the unicast/MBMS cell. Moreover, when the reception level of the MBMS-dedicated cell exceeds a second threshold value obtained by adding an offset value to the first threshold value, the serving MBMS cell is switched from the unicast/MBMS cell to the MBMS-dedicated cell.

### TECHNICAL FIELD

The present invention relates to a radio transmitting apparatus, radio receiving apparatus, cell switching method and radio communication system.

### BACKGROUND ART

In the field of mobile communication, in recent years, technological studies on a multimedia broadcast/multicast service (hereinafter referred to as “MBMS”), which is a broadcasting service or multicast service, are underway. MBMS is not one-to-one communication but one-to-multiple communication and one base station transmits the same data to a plurality of communication terminals simultaneously.

Advantages of MBMS are as follows. That is, when different communication terminals receive information transmitted from a base station in a streaming service and so forth using one dedicated channel respectively, if the number of communication terminals that desire to receive the information increases, the load on the radio channel increases. On the other hand, when MBMS is used, even when the number of communication terminals that desire to receive the same information increases, all the communication terminals receive the information using the same channel, and therefore it is possible to prevent the load on the radio channel from increasing. Currently, as services using MBMS, delivery of traffic information, music delivery, news delivery, sports casting and so forth are under study.

FIG. 1 illustrates a configuration of a general radio communication network to which MBMS is applied. The network shown in FIG. 1 has communication terminal (UE: User Equipment) 1301, base station (eNB: E-UTRAN NodeB) 1302, MBMS control apparatus (MCE: Multi-cell/multicast Coordination Entity) 1303 and MBMS gateway (MBMS gateway) 1304.

eNB 1302 performs radio resource allocation and management, and serves as an access point of the radio access network. MCE 1303 manages a plurality of eNBs 1302 and allocates physical resource blocks for an MBMS service. MBMS gateway 1304 is a backbone of the mobile communication network and performs delivery of MBMS contents and control of MBMS data and session and so forth.

3GPP LTE (3rd Generation Partnership Project) defines two types of cells for MBMS. One is an MBMS dedicated cell and the other is a unicast/MBMS mixed cell. The MBMS dedicated cell provides only an MBMS service. On the other hand, the unicast/MBMS mixed cell provides both a unicast service and a MBMS service.

FIG. 2 is a conceptual diagram illustrating an area configuration of a MBMS dedicated cell and a unicast/MBMS mixed cell. The MBMS dedicated cell is a cell having only a downlink and there is no uplink from the UE to the eNB. Thus, when only the downlink is considered, radio wave can be emitted over a wide range by enhancing transmission power of the eNB, and therefore the area of the MBMS dedicated cell can be considered to be set wider than the unicast/MBMS mixed cell. Both an uplink and a downlink exist in the unicast/MBMS mixed cell.

When such two types of cells exist, the UE receives system information and paging from the unicast/MBMS mixed cell. This is referred to as the UE “camping on” the unicast/MBMS mixed cell. To receive an MBMS service from the MBMS dedicated cell while camping on the unicast/MBMS mixed cell to receive paging, the UE moves to the MBMS dedicated cell as required. Taking advantage of the characteristics of the area configuration described above, the MBMS dedicated cell is considered to provide a common MBMS service over a wide area such as music delivery and mobile TV, whereas the unicast/MBMS mixed cell is considered to provide an MBMS service targeted at a limited area such as information delivery to a limited region (see Non-Patent Document 1 and Non-Patent Document 2).

Here, in the MBMS dedicated cell, when a receiving quality deteriorates in an area where radio wave is in a poor condition such as in a tunnel or subway, a method is considered which complements delivery of an MBMS service from the MBMS dedicated cell by temporarily using the unicast/MBMS mixed cell. This method will be described using FIG. 3.

First, suppose the UE is receiving an MBMS service from the MBMS dedicated cell using the serving MBMS cell, which is a cell that currently provides the MBMS service, as the MBMS dedicated cell (ST 1501 and ST 1502). The UE measures reception levels of the MBMS dedicated cell and the unicast/MBMS mixed cell (ST 1503 and ST 1504) and determines, when the reception level of the unicast/MBMS mixed cell is higher than the reception level of the MBMS dedicated cell, to switch the serving MBMS cell to the unicast/MBMS mixed cell (ST 1505).

When the UE determines to switch the serving MBMS cell to the unicast/MBMS mixed cell, the UE transmits an RRC connection request message (RRC connection request) to the eNB of the unicast/MBMS mixed cell (ST 1506), and when the UE receives an RRC connection setup message from the eNB, an RRC connection is established (ST 1507). After that, the eNB of the unicast/MBMS mixed cell transmits a message (request) to request the eNB of the MBMS dedicated cell for an IP address of IP multicast to receive the corresponding MBMS service (ST 1508), transmits an ID and an IP address of the corresponding MBMS service to the MCE based on the IP address (Ack) returned from the eNB of the MBMS dedicated cell (ST 1509), requests (Join) transfer of MBMS data (ST 1510) and acquires the corresponding MBMS data from the MCE (ST 1511).

The UE then receives an MBMS service from the unicast/MBMS mixed cell using the unicast/MBMS mixed cell as the serving MBMS cell (ST 1512). While receiving the MBMS data from the unicast/MBMS mixed cell, the UE measures reception levels of the MBMS dedicated cell and the unicast/MBMS mixed cell (ST 1513 and ST 1514) and transmits, when the reception level of the MBMS dedicated cell is higher than that of the unicast/MBMS mixed cell again, a measurement result report (measurement report) to the base station of the unicast/MBMS mixed cell (ST 1515).

When receiving the measurement result report from the UE, the eNB of the unicast/MBMS mixed cell transmits an RRC connection release message to make the UE determine to switch the serving MBMS cell from the unicast/MBMS mixed cell to the MBMS dedicated cell again (ST 1516) and switch the cell (ST 1517). The eNB of the unicast/MBMS mixed cell sends an MBMS data transmission stop request message (MBMS data stop request) to the MCE (ST 1518) and the UE receives the MBMS service from the MBMS dedicated cell again (ST 1519 and ST 1520).

### Non-Patent Document 1: 3GPP TS25.331 v8.4.0 “Radio Resource Control”

Non-Patent Document 2: 3GPP TS36.300 v8.6.0 “E-UTRA and E-UTR AN Overall description stage 2”

### DISCLOSURE OF INVENTION

### Problems to be Solved by the Invention

However, according to the method described above, when the reception level of the unicast/MBMS mixed cell is higher than that of the MBMS dedicated cell, the serving MBMS cell is switched to the unicast/MBMS mixed cell, and therefore although the receiving quality of the MBMS dedicated cell is good, the serving MBMS cell may be switched to the unicast/MBMS mixed cell. As a result of this, although it is possible to receive a sufficient service in the MBMS dedicated cell, resources of the unicast/MBMS mixed cell may be wasted.

Furthermore, there is another problem that the UE which has switched the serving MBMS cell from the unicast/MBMS mixed cell to the MBMS dedicated cell immediately switches the serving MBMS cell to the unicast/MBMS mixed cell, and therefore the amount of signaling accompanying cell switching increases.

It is therefore an object of the present invention to provide a radio transmitting apparatus, radio receiving apparatus, cell switching method and radio communication system that effectively utilize resources of a unicast/MBMS mixed cell and prevent the amount of signaling accompanying cell switching from increasing.

### Means for Solving the Problem

The radio transmitting apparatus according to the present invention adopts a configuration including a storage section that stores a first value indicating a reception level of a multimedia broadcast/multicast service dedicated cell to be used as a reference for switching from the MBMS dedicated cell to a unicast/multimedia broadcast/multicast service mixed cell and a second value used for a reference for switching from the unicast/multimedia broadcast/multicast service mixed cell to the multimedia broadcast/multicast service dedicated cell; and a transmitting section that transmits the first value and the second value as system information.

The radio receiving apparatus according to the present invention adopts a configuration including a receiving section that receives a first value indicating a reception level of a multimedia broadcast/multicast service dedicated cell used for a reference for switching from the MBMS dedicated cell to a unicast/multimedia broadcast/multicast service mixed cell and a second value used for a reference for switching from the unicast/multimedia broadcast/multicast service mixed cell to the multimedia broadcast/multicast service dedicated cell; a measuring section that measures a reception level of the MBMS dedicated cell; a judging section that judges whether or not to perform cell switching based on the measured reception level, the first value and the second value; and a cell switching control section that performs cell switching control in accordance with the judgment result.

The cell switching method according to the present invention includes the steps of: measuring a reception level of an MBMS dedicated cell; performing threshold judgment on the measured reception level with a first value and a second value greater than the first value, judging, when the reception level is lower than the first value, that switching is to be performed from the multimedia broadcast/multicast service dedicated cell to the unicast/multimedia broadcast/multicast service mixed cell and judging, when the reception level is higher than the second value, that switching is to be performed from the unicast/multimedia broadcast/multicast service mixed cell to the multimedia broadcast/multicast service dedicated cell; and performing cell switching control in accordance with the judgment result.

The radio communication system according to the present invention adopts a configuration including a unicast/multimedia broadcast/multicast service mixed cell radio communication base station apparatus comprising: a receiving section that receives a service request from a radio communication terminal apparatus; and a transmitting section that transmits system information and paging and transmits MBMS data in response to the service request, a multimedia broadcast/multicast service dedicated cell radio communication base station apparatus comprising: a storage section that stores a first value indicating a reception level of a multimedia broadcast/multicast service dedicated cell used for a reference for switching from the MBMS dedicated cell to a unicast/multimedia broadcast/multicast service mixed cell and a second value used for a reference for switching from the Unicast/multimedia broadcast/multicast service mixed cell to the multimedia broadcast/multicast service dedicated cell; and a transmitting section that transmits the first value and the second value as system information, a radio communication terminal apparatus comprising: a receiving section that receives the first value and the second value transmitted from the multimedia broadcast/multicast service dedicated cell radio communication base station apparatus; a measuring section that measures the reception level of the multimedia broadcast/multicast service dedicated cell; a judging section that judges whether or not to perform cell switching based on the measured reception level, the first value and the second value; and a cell switching control section that performs cell switching control in accordance with the judgment result.

### ADVANTAGEOUS EFFECTS OF INVENTION

According to the present invention, it is possible to effectively utilize resources of a unicast/MBMS mixed cell and prevent the amount of signaling accompanying cell switching from increasing.

### BRIEF DESCRIPTION OF DRAWINGS

FIG. 1 is a diagram illustrating a configuration of a general radio communication network to which MBMS is applied;

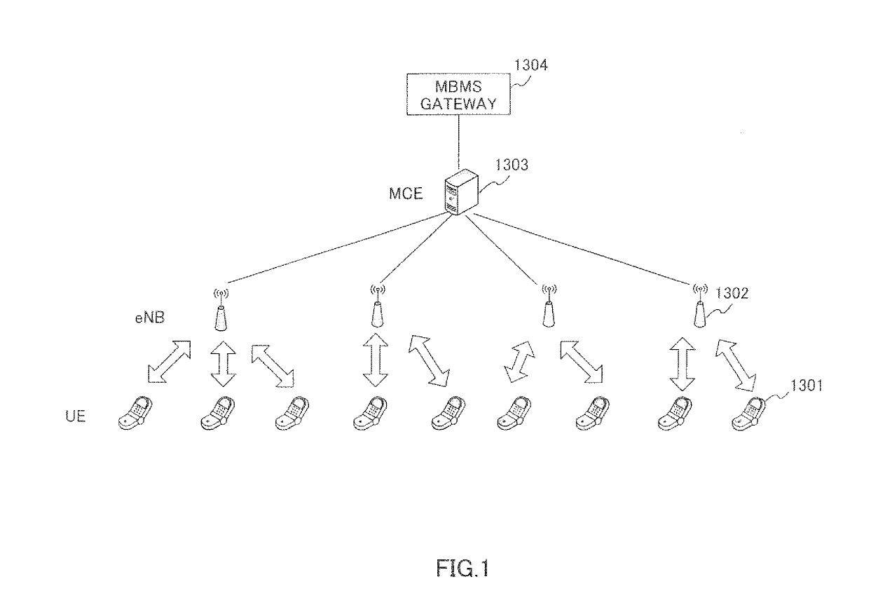

FIG. 2 is a conceptual diagram illustrating an area configuration of an MBMS dedicated cell and a unicast/MBMS mixed cell;

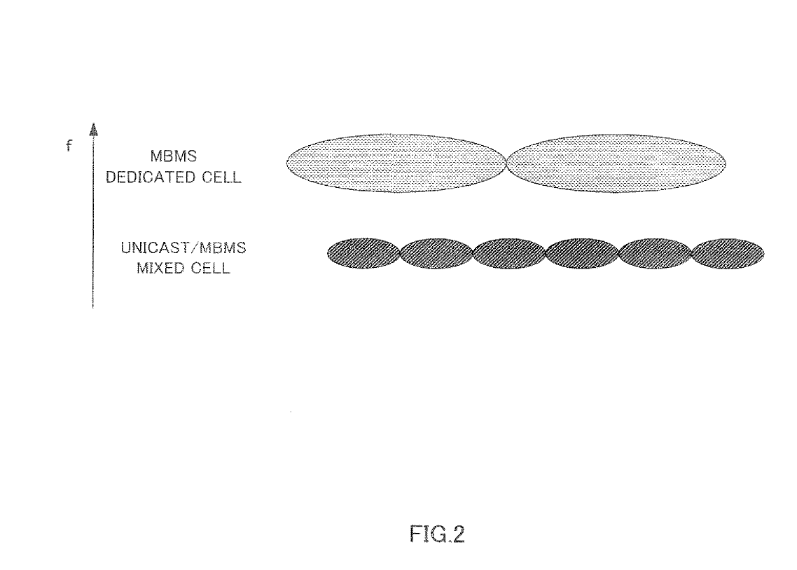

FIG. 3 is a sequence diagram illustrating a method of complementing supply of an MBMS service from an MBMS dedicated cell by temporarily using a unicast/MBMS mixed cell;

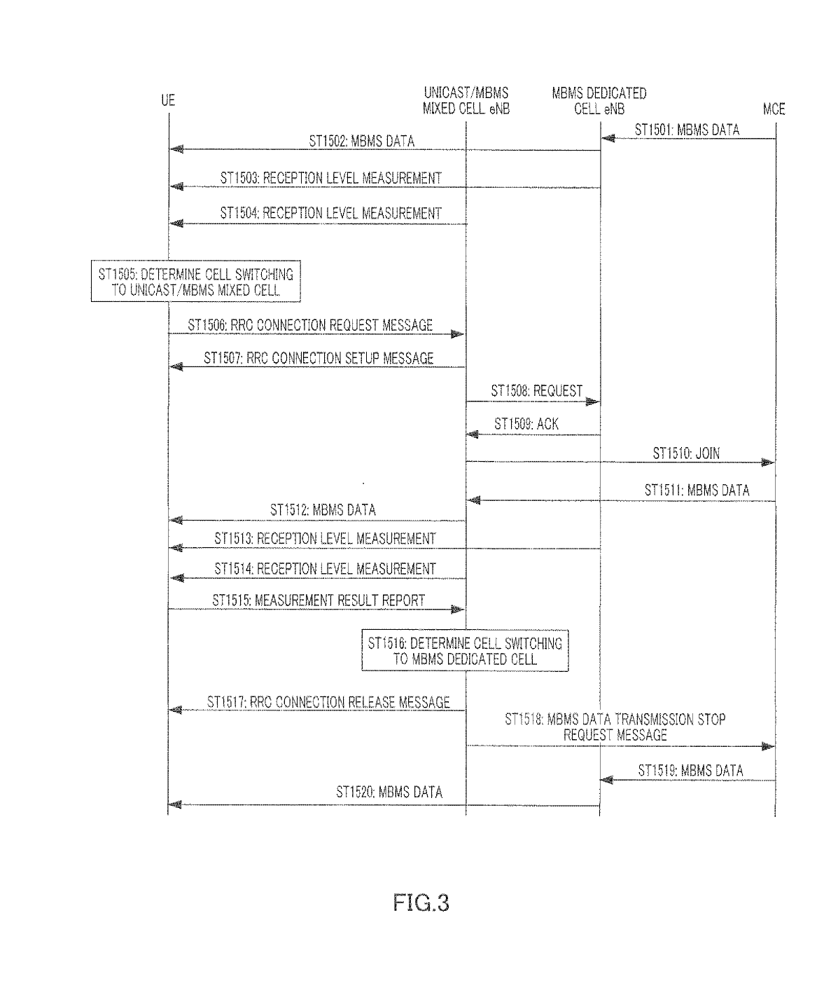

FIG. 4 is a sequence diagram illustrating operations of the UE according to embodiment 1 of the present invention to switch a serving MBMS cell;

FIG. 5 is a block diagram illustrating a configuration of an eNB according embodiment 1 of the present invention;

FIG. 6 is a block diagram illustrating a configuration of the UE according to embodiment 1 of the present invention;

FIG. 7 is a flowchart illustrating operations of the UE shown in FIG. 6 to switch the serving MBMS cell;

FIG. 8 is a sequence diagram illustrating operations of the UE and eNB when a cell switching waiting time is set;

FIG. 9 is a block diagram illustrating a configuration of a UE according to embodiment 2 of the present invention;

FIG. 10 is a flowchart illustrating operations of the UE shown in FIG. 9 to switch a serving MBMS cell;

FIG. 11 is a conceptual diagram illustrating a method calculating a cell switching waiting time;

FIG. 12 is a conceptual diagram illustrating an area configuration according to embodiment 3 of the present invention;

FIG. 13 is a sequence diagram illustrating operations of the UE according to embodiment 3 of the present invention to switch a serving MBMS cell;

FIG. 14 is a sequence diagram illustrating operations of the UE and eNB of a unicast/MBMS mixed cell according to embodiment 4 of the present invention; and

FIG. 15 is a block diagram illustrating a configuration of the eNB according to embodiment 4 of the present invention.

### BEST MODE FOR CARRYING OUT THE INVENTION

Hereinafter, embodiments of the present invention will be explained in detail with reference to the accompanying drawings. However, components having the same functions among embodiments will be assigned the same reference numerals and overlapping descriptions will be omitted.

Furthermore, although the following embodiments of the present invention will be described based on the above-described 3GPP LTE communication system, the present invention is not limited to this and also applicable to other communication systems (e.g., communication systems such as IMT-Advanced, IEEE802.16m).

### Embodiment 1

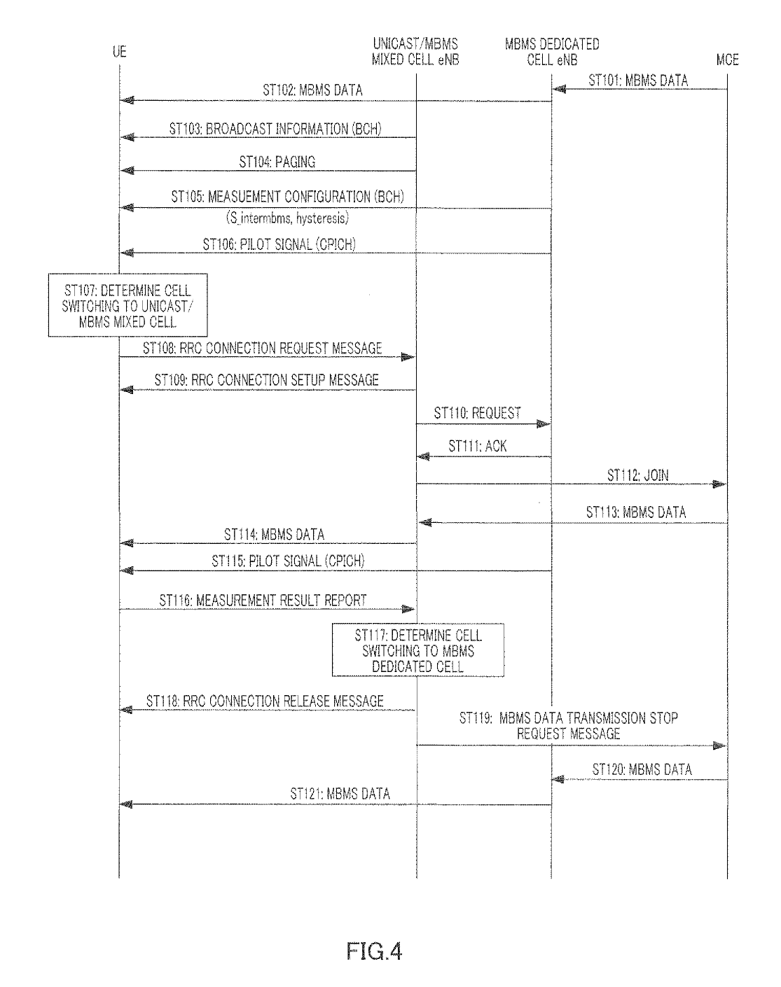

Operations of the UE according to embodiment 1 of the present invention to switch a serving MBMS cell will be described using FIG. 4. First, suppose the UE receives an MBMS service from an MBMS dedicated cell using the MBMS dedicated cell as a serving MBMS cell (ST 101 and ST 102). Furthermore, the UE camps on a unicast/MBMS mixed cell and receives system information from an eNB of the unicast/MBMS mixed cell (ST 103).

Here, when a request for arrival of a voice call to the UE is made, a base station in the unicast/MBMS mixed cell belonging to a tracking area with which the UE is registered transmits paging (calling) (ST 104).

System information, paging and so forth is received for a period (gap) during which MBMS data is not being transmitted while the UE is receiving an MBMS service from the MBMS dedicated cell.

Since the UE does not camp on the MBMS dedicated cell, the UE need not perform cell reselection in the MBMS dedicated cell. Therefore, no parameter for cell reselection is originally sent in the MBMS dedicated cell. However, the present embodiment will use a threshold of a reception level as a reference for switching the serving MBMS cell from the MBMS dedicated cell to the unicast/MBMS mixed cell. This threshold is defined as first threshold S_intermbms. S_intermbms is reported to the UE as system information of the MBMS dedicated cell (ST 105).

The UE periodically measures the reception level of the MBMS dedicated cell using a pilot channel (CPICH: Common Pilot Channel) (ST 106) and determines, when the reception level lower than the first threshold, to switch the serving MB MS cell to the unicast/MBMS mixed cell (ST 107).

When determining that the serving MBMS cell is switched to the unicast/MBMS mixed cell, the UE transmits an RRC connection request message to the eNB of the unicast/MBMS mixed cell (ST 108). The RRC connection request message includes an ID for identifying the UE, an ID for identifying the MBMS service requested and an MBMS service request message indicating a connection request to receive an MBMS service, which is temporarily provided in the MBMS dedicated cell and so forth.

The eNB of the unicast/MBMS mixed cell, which has received, from the UE, the RRC connection request message including the service request, transmits an RRC connection setup message to the UE (ST 109). When the UE receives the RRC connection setup message, an RRC connection is established. After that, the eNB of the unicast/MBMS mixed cell transmits, to the eNB of the MBMS dedicated cell, a message for requesting an IP address of IP multi east to receive the corresponding MBMS service (ST 110), transmits an ID and an IP address of the corresponding MBMS service to the MCE based on the IP address returned from the MBMS dedicated cell (ST 111), requests transfer of MBMS data (ST 112) and acquires the corresponding MBMS data from the MCE (ST 113).

The UE then receives an MBMS service from the unicast/MBMS mixed cell using the unicast/MBMS mixed cell as the serving MBMS cell (ST 114). Furthermore, when the serving MBMS cell is switched from the unicast/MBMS mixed cell to the MBMS dedicated cell again, a second threshold is used. Here, a value resulting from adding a predetermined value (offset value) to the value of S_intermbms is used as the second threshold. Suppose this offset value is hysteresis. The value of hysteresis is reported to the UE through system information of the MBMS dedicated cell simultaneously with S_intermbms in ST 105.

The UE measures the reception level of the MBMS dedicated cell using a pilot channel (CPICH: Common Pilot Channel) (ST 115), and when the reception level of the MBMS dedicated cell is higher than the second threshold (S_intermbms+hysteresis), the UE transmits a measurement result report (measurement report) to the eNB of the unicast/MBMS mixed cell (ST 116). When receiving the measurement result report from the UE, the unicast/MBMS mixed cell transmits an RRC connection release message to make the UE determine to switch the serving MBMS cell from the unicast/MBMS mixed cell to the MBMS dedicated again (ST 117) and switch the cell (ST 118). The eNB of the unicast/MBMS mixed cell sends an MBMS data transmission stop request message to the MCE (ST 119) and the UE receives an MBMS service from the MBMS dedicated cell again (ST 120 and ST 121).

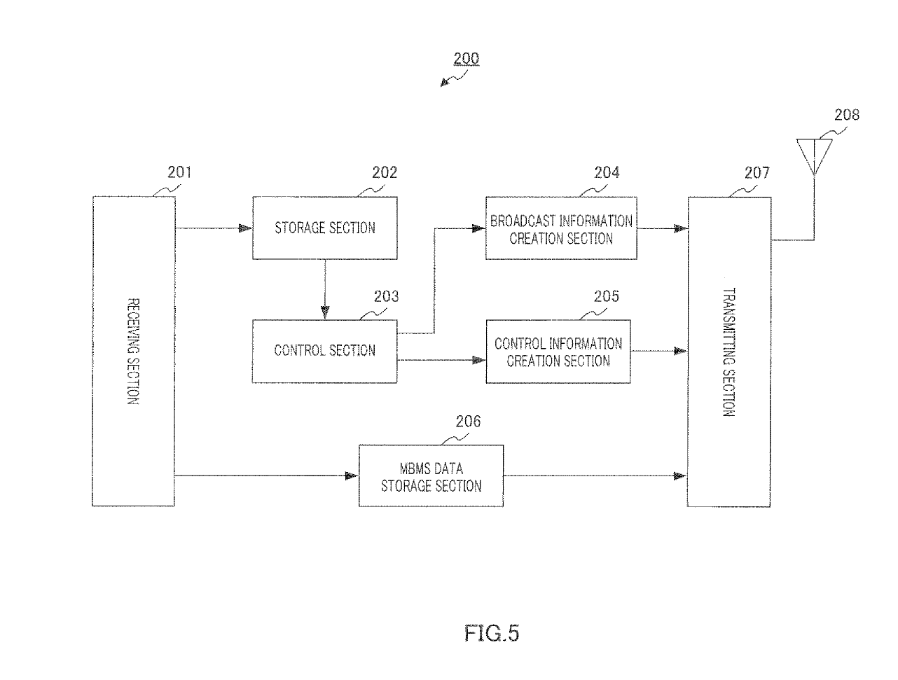

Next, a configuration of eNB 200 according to embodiment 1 of the present invention will be described using FIG. 5. Receiving section 201 receives data related to the MBMS service, control information and so forth from the MCE and also receives an MBMS service request and so forth from the UE.

Storage section 202 stores measurement parameters such as a threshold of the reception level used as a reference for switching the serving MBMS cell, an offset value, specification of a measuring target, a transmission timing of a measurement result report, and MBMS-related information such as system information necessary to receive an MBMS service an information element of access information.

Control section 203 outputs the measurement parameter inputted from storage section 202 to system information creation section 204 and also outputs the MEMS-related information inputted from storage section 202 to control information creation section 205.

System information creation section 204 generates system information including the measurement parameter inputted from control section 203 and outputs the system information to transmitting section 207.

Control information creation section 205 generates MBMS control information such as system information or access information based on the MBMS-related information inputted from control section 203 and outputs the MBMS control information to transmitting section 207.

MBMS data storage section 206 stores data concerning the MBMS service inputted from receiving section 201.

Transmitting section 207 transmits the information inputted from system information creation section 204, control information creation section 205 and MBMS data storage section 206 from antenna 208.

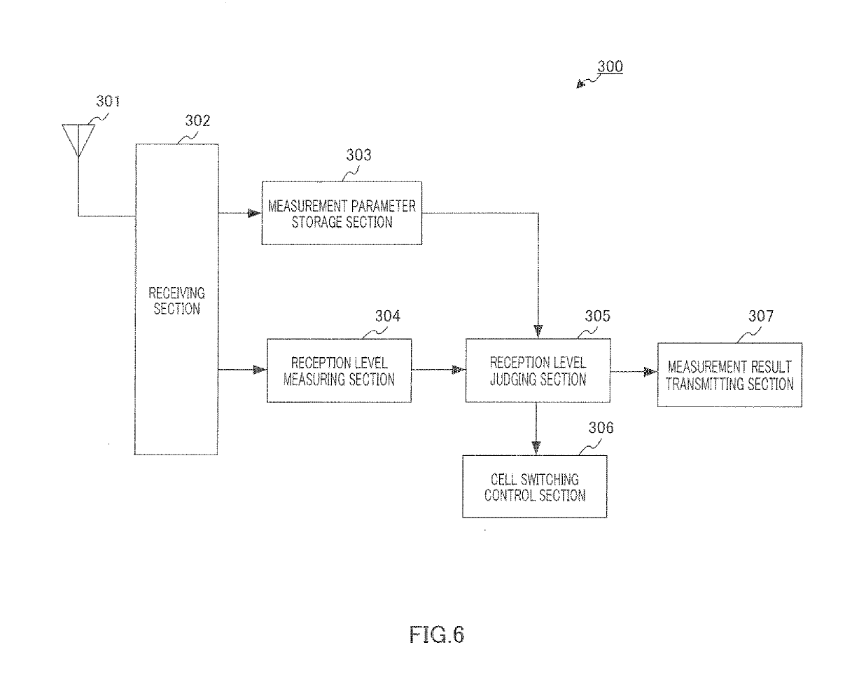

Next, a configuration of UE 300 according to embodiment 1 of the present invention will be described using FIG. 6. Receiving section 302 receives system information or user data and so forth transmitted from the eNB via antenna 301.

Measurement parameter storage section 303 stores thresholds of reception levels of serving MBMS cell switching references inputted from receiving section 302.

Reception level measuring section 304 measures the reception level of the MBMS dedicated cell using a pilot signal inputted from receiving section 302 and outputs the measurement result to reception level judging section 305.

Reception level judging section 305 acquires a first threshold and a second threshold resulting from adding an offset value to the first threshold from measurement parameter storage section 303, compares the acquired first threshold and second threshold with the reception level inputted from reception level measuring section 304 and judges whether or not to switch the serving MBMS cell. When the reception level is lower than the first threshold, reception level judging section 305 commands cell switching control section 306 to switch the serving MBMS cell and when the reception level is higher than the second threshold, reception level judging section 305 commands measurement result transmitting section 307 to transmit the measurement result to the eNB.

Cell switching control section 306 switches the serving MBMS cell based on the judgment result inputted from reception level judging section 305.

Measurement result transmitting section 307 transmits the result of the measured reception level to the eNB based on the judgment result inputted from reception level judging section 305.

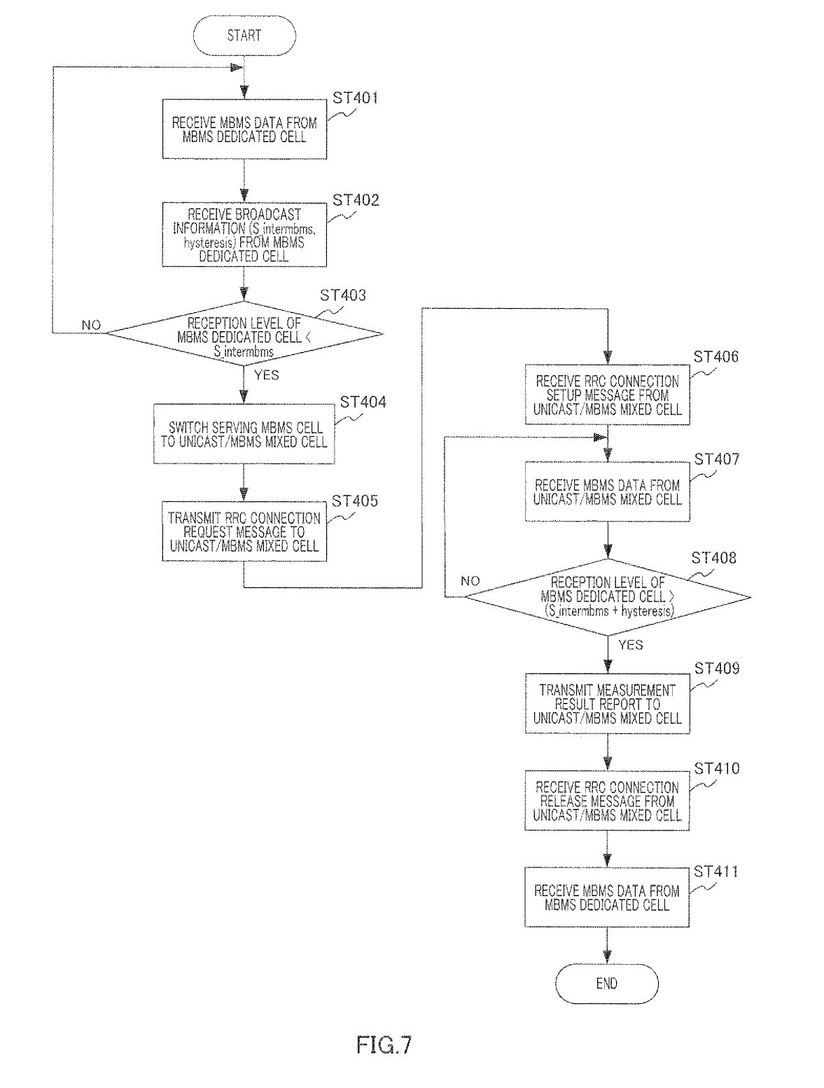

Next, operations of the UE shown in FIG. 4 to switch the serving MBMS cell will be described using FIG. 7. First, suppose the UE receives MBMS data from the MBMS dedicated cell using the MEMS dedicated cell as the serving MBMS cell (ST401). The UE acquires a threshold (S_intermbms) of the reception level and an offset value (hysteresis) as parameters for switching serving MBMS cell through the system information of the MBMS dedicated cell (ST402). The UE measures the reception level of the MBMS dedicated cell, compares the reception level of the MBMS dedicated cell with the first threshold and judges, when the reception level of the MBMS dedicated cell is lower than the first threshold, that the serving MBMS cell is to be switched to the unicast/MBMS mixed cell (ST403 and ST404). On the other hand, when the reception level of the MBMS dedicated cell is equal to or higher than the first threshold, the UE continues to receive the MBMS service from the MBMS dedicated cell (ST403 and ST401).

When the UE judges that the serving MBMS cell is to be switched to the unicast/MBMS mixed cell, the UE transmits an RRC connection request message including an MBMS service request to the unicast/MBMS mixed cell as serving MBMS cell switching processing (ST405) and receives an RRC connection setup message from the unicast/MBMS mixed cell that has received the RRC connection request message (ST406). After an RRC connection is established between the UE and the eNB of the unicast/MBMS mixed cell, the UE receives MBMS data from the unicast/MBMS mixed cell (ST407). The UE measures the reception level of the MBMS dedicated cell while receiving the MBMS data in the unicast/MBMS mixed cell, compares the reception level of the MBMS dedicated cell with the second threshold and transmits, when the reception level of the MBMS dedicated cell is higher than the second threshold, the measurement result to the unicast/MBMS mixed cell (ST408 and ST409). When the reception level of the MBMS dedicated cell is equal to or lower than the second threshold, the UE continues to receive MBMS data from the unicast/MBMS mixed cell and measure the reception level of the MBMS dedicated cell (ST408 and ST407).

After transmitting the measurement result to the unicast/MBMS mixed cell, the UE releases the RRC connection according to a command of the RRC connection release message transmitted from the unicast/MBMS mixed cell (ST410), and receives MBMS data from the MBMS dedicated cell again (ST411).

As described above, according to embodiment 1, the UE measures the reception level of the MBMS dedicated cell, switches, when the measured reception level is lower than the first threshold, the serving MBMS cell from the MBMS dedicated cell to the unicast/MBMS mixed cell, and therefore can continue to receive the service in the MBMS dedicated cell until the reception level of the MBMS dedicated cell is lower than the first threshold, so that unnecessary cell switching to the unicast/MBMS mixed cell can be prevented. By this means, it is possible to prevent resources of the unicast/MBMS mixed cell from being wasted.

Moreover, switching the serving MBMS cell from the unicast/MBMS mixed cell to the MBMS dedicated cell when the reception level of the MBMS dedicated cell is higher than the second threshold resulting from adding an offset value to the first threshold allows the UE to switch to the MBMS dedicated cell after the reception level of the MBMS dedicated cell has recovered sufficiently, and therefore it is possible to prevent the UE from immediately switching the serving MBMS cell to the unicast/MBMS mixed cell and suppress an increase in the amount of signaling caused by frequent cell switching.

The unicast/MBMS mixed cell may also be referred to as “unicast/MBMS shared cell” or “unicast/MBMS hybrid cell.”

### Embodiment 2

Although a case has been described in embodiment 1 where switching between the MBMS dedicated cell and the unicast/MBMS mixed cell is performed based on threshold judgment on the reception level of the MBMS dedicated cell with a first threshold and a second threshold resulting from adding an offset value to the first threshold, a timing of switching a serving MBMS cell will be described in embodiment 2 of the present invention.

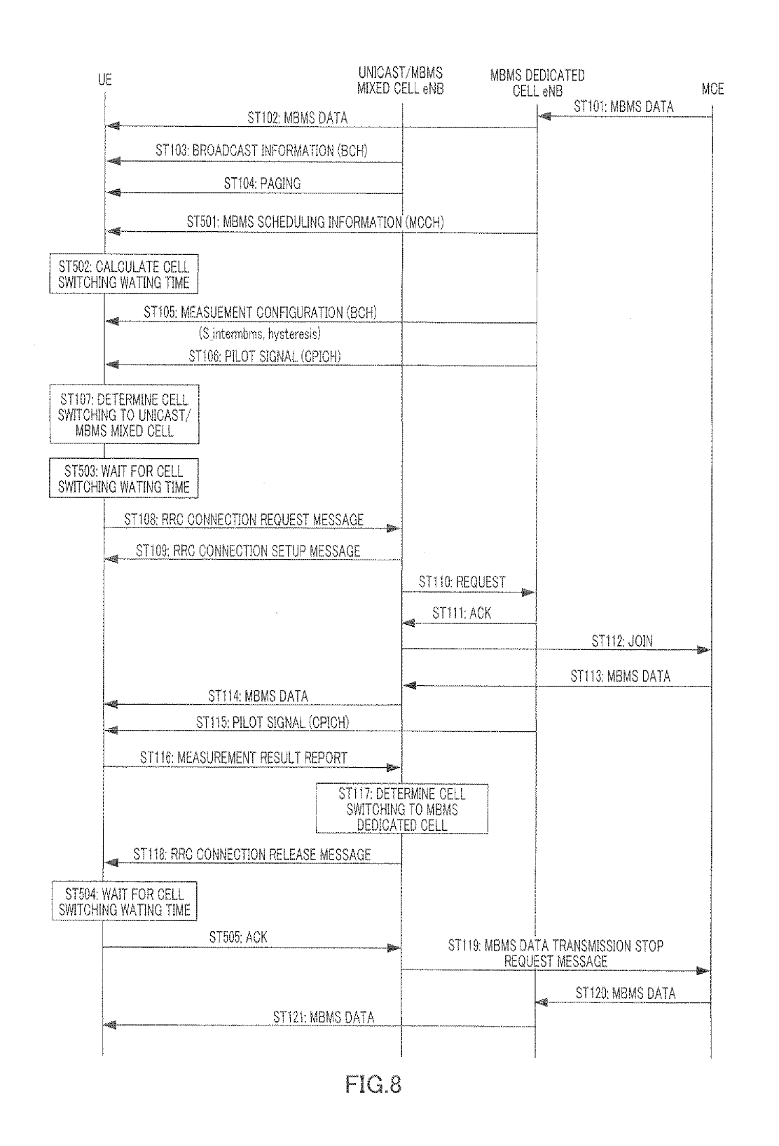

When there is a difference between a MBMS data transmission timing and a serving MBMS cell switching timing, the UE may not be able to receive MBMS data and the MBMS data may be lost. Thus, to prevent this data loss, the period after the reception level of the MBMS dedicated cell is lower than the first threshold until the UE starts switching the serving MBMS cell or the period after the reception level of the MBMS dedicated cell is higher than the second threshold until the eNB commands the UE to switch the serving MBMS cell, is set. This period is a cell switching waiting time (T_reselection). Now, operations of the UE and the eNB when the cell switching waiting time is set will be described using FIG. 8. Here, in FIG. 8, the same parts as in FIG. 4 will be assigned the same reference numerals and overlapping descriptions will be omitted.

The UE receives MBMS scheduling information, which is a message indicating a timing at which an MBMS service is actually transmitted, from the eNB via a multicast control channel (MCCH) (ST501). The UE calculates a cell switching waiting time from a parameter included in MBMS scheduling information (ST502).

After determining to switch from the MBMS dedicated cell to the unicast/MBMS mixed cell in ST 107, the UP waits for a cell switching time (ST503) and then transmits an RRC connection request message including an MBMS service request to the base station of the unicast/MBMS mixed cell (ST 108).

On the other hand, after switching from the unicast/MBMS mixed cell to the MBMS dedicated cell is determined in ST 117, the UE, which has received an RRC connection release message in ST 118, waits for a cell switching waiting time (ST504) and then returns a response message (Ack) to the base station of the unicast/MBMS mixed cell (ST505).

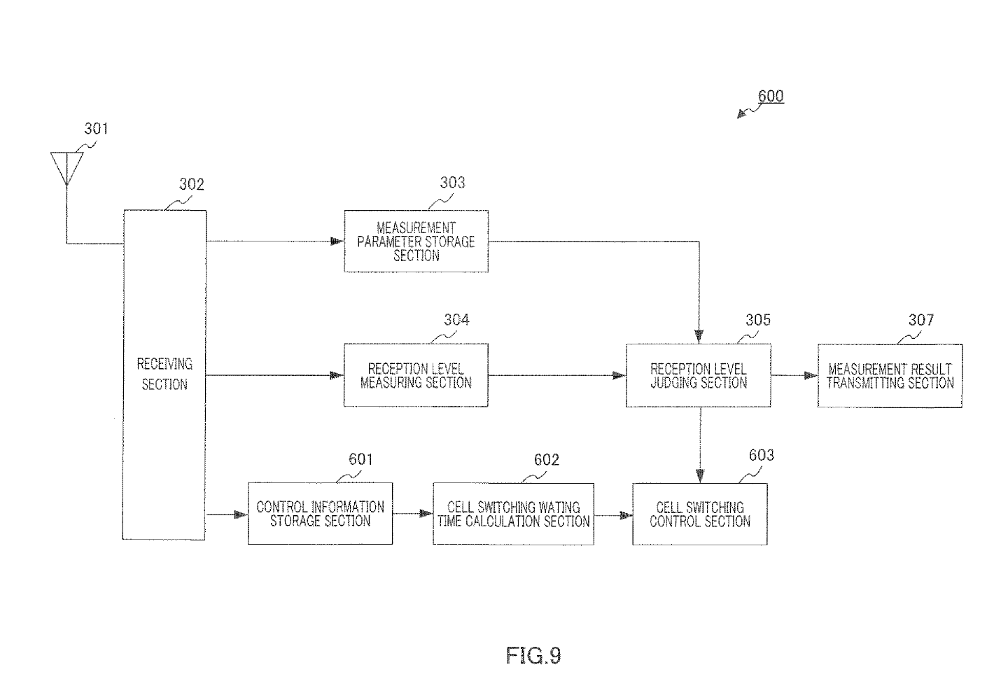

Next, a configuration of UE 600 according to embodiment 2 of the present invention will be described using FIG. 9. Control information storage section 601 stores MBMS control information inputted from receiving section 302.

Cell switching waiting time calculation section 602 extracts a parameter such as a next scheduling period from scheduling information of the MBMS service acquired from control information storage section 601, and calculates the cell switching waiting time using the extracted parameter. The next scheduling period is a value indicating the number of periods during which data is not transmitted until the next MBMS data is transmitted for a certain period (scheduling period) including a time during which MBMS data is transmitted. The calculated cell switching waiting time is outputted to cell switching control section 603.

Cell switching control section 603 waits for the cell switching waiting time inputted from cell switching waiting time calculation section 602 and executes switching of the serving MBMS cell based on the judgment result inputted from reception level judging section 305.

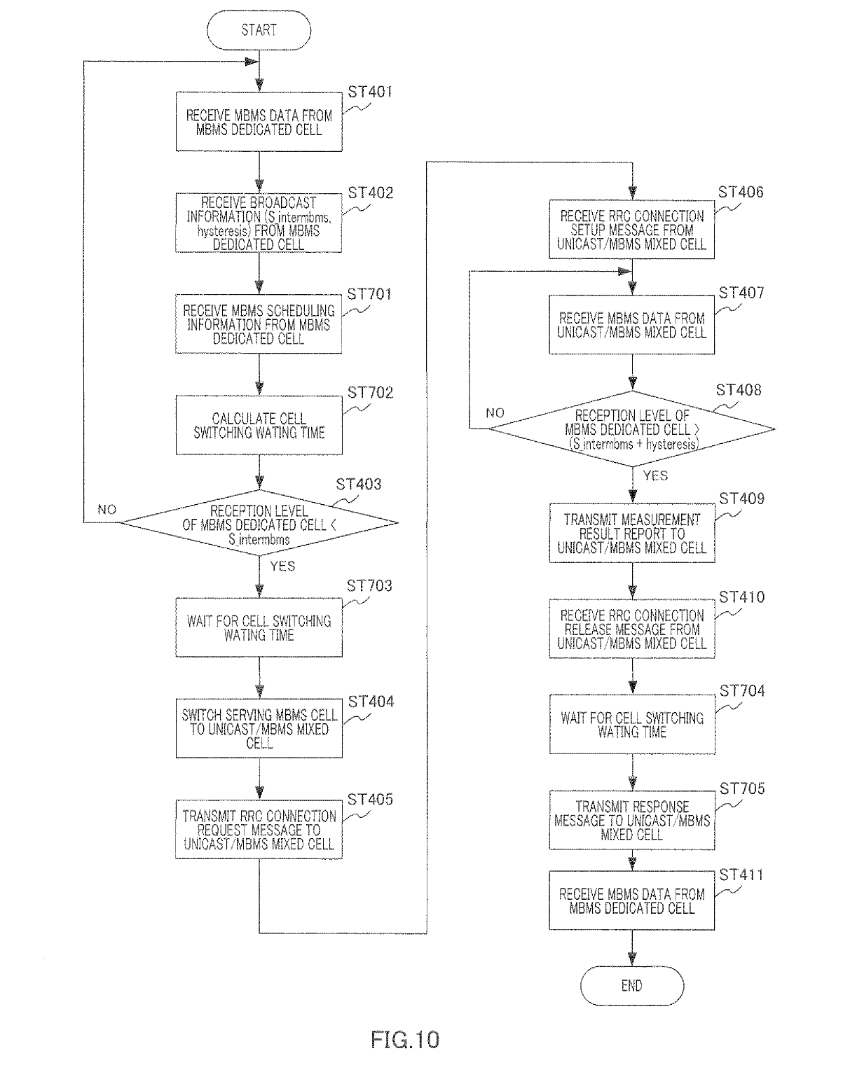

Next, operations of the UE shown in FIG. 9 to switch the serving MBMS cell will be described using FIG. 10. Here, in FIG. 10, the same parts as in FIG. 7 will be assigned the same reference numerals and overlapping descriptions will be omitted.

In ST402, the UE, which has acquired a threshold (S_intermbms) of the reception level and an offset value (hysteresis) from the system information of the MBMS dedicated cell as parameters for switching serving MBMS cell, receives MBMS scheduling information, which is a message indicating a timing at which an MBMS service is actually transmitted, from the eNB via a multicast control channel (MCCH) (ST701).

The UE then calculates a cell switching waiting time using the parameters included in the MBMS scheduling information (ST702). When it is determined in ST403 that the serving MBMS cell is switched to the unicast/MBMS mixed cell, the UE waits for a cell switching time (ST703).

Moreover, in ST408 to ST410, when the reception level of the MBMS dedicated cell is higher than the second threshold, the UE transmits a measurement result report to the eNB of the unicast/MBMS mixed cell, and when receiving the RRC connection release message transmitted from the unicast/MBMS mixed cell, the UE waits for the cell switching waiting time (ST704). After that, the UE returns a response message (Ack) to the eNB of the unicast/MBMS mixed cell (ST705).

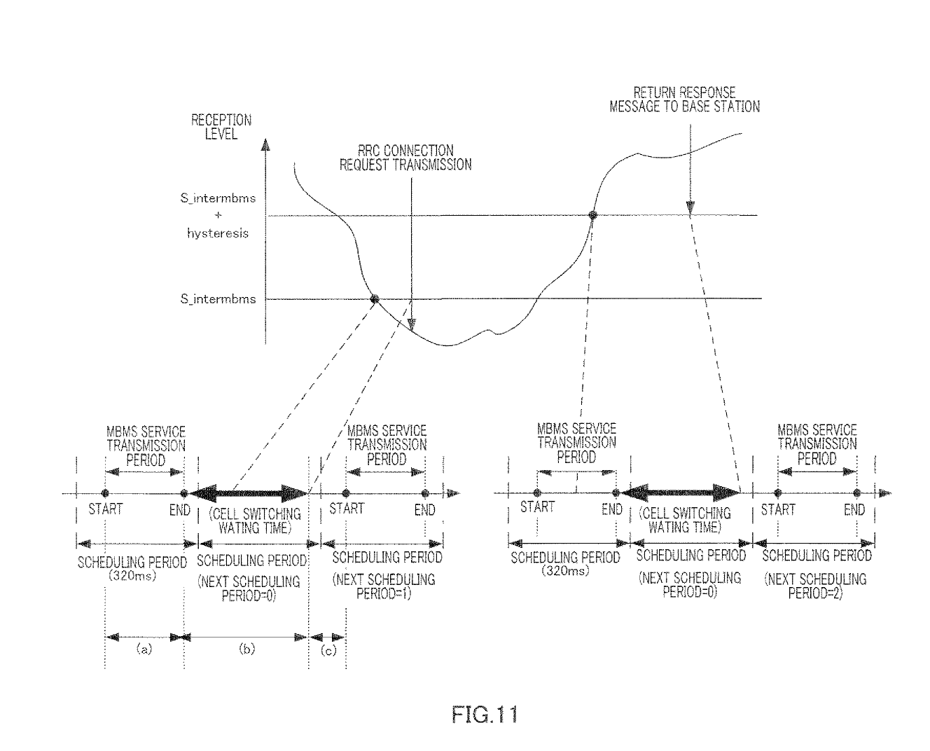

Here, a method of calculating a cell switching waiting time will be described using an example shown in FIG. 11. The timing at which the MBMS service is actually transmitted is reported to the UE using the parameters included in the MBMS scheduling information. The scheduling information includes a value indicating a range of a certain period including the time during which MBMS data is transmitted (hereinafter referred to as “scheduling period”) and the value indicating the number of periods during which data is not transmitted until the next data is transmitted (hereinafter referred to as “next scheduling period”). Examples of the scheduling period include 320 ms, 620 ms, . . . , 10240 ms.

The cell switching waiting time is calculated by multiplying the scheduling period by the next scheduling period. In FIG. 11, the scheduling period is 320 ms and the next scheduling period is 1. In this case, the cell switching waiting time is 320 ms (320 ms×1).

To be more specific, when the reception level of the MBMS dedicated cell is lower than the first threshold (S_intermbms), the UE waits for the cell switching waiting time (320 ms in FIG. 11) after the immediately preceding MBMS service transmission is finished and transmits an RRC connection request to the eNB of the unicast/MBMS mixed cell. Moreover, after that, when the reception level of the MBMS dedicated cell is higher than the second threshold (S_intermbms+hysteresis), the UE likewise waits for the cell switching waiting time (320 ms in FIG. 11) after the immediately preceding MBMS service transmission is finished and returns a response to the RRC connection release message to the eNB.

Here, the timing of the serving MBMS cell switching operation of the UE is classified into the following three cases. The first one is a case where when the reception level of the MBMS dedicated cell is higher than a threshold (lower than the first threshold or higher than the second threshold) during MBMS data transmission (period (a) in FIG. 11), the UE waits for the cell switching waiting time after transmission of MBMS data is finished and executes a cell switching operation.

The second one is a ease where when MBMS data is not transmitted and the reception level of the MBMS dedicated cell is higher than a threshold within a range of the cell switching waiting time (period (b) in FIG. 11), the UE waits until the end of the cell switching waiting time and executes a cell switching operation.

The third one is a case where when the reception level of the MBMS dedicated cell is higher than a threshold for a period until the next MBMS data transmission starts after the end of the cell switching waiting time (period (c) in FIG. 11), the UE immediately executes cell switching operation.

As described above, according to embodiment 2, in consideration of the difference between the timing of switching the serving MBMS cell and the timing at which MBMS data is actually transmitted, by setting a period until the UE starts switching of the serving MBMS cell after the reception level of the MBMS dedicated cell is lower than the first threshold or a cell switching waiting time until the eNB instructs the UE to switch the serving MBMS cell after the reception level is higher than the second threshold, it is possible to prevent UEs from switching the serving MBMS cell to the unicast/MBMS mixed cell all at once, prevent the UEs from concentrating on the unicast/MBMS mixed cell and suppress an increase in the amount of signaling of the unicast/MBMS mixed cell. Moreover, since the difference between the timing at which MBMS data is transmitted and the timing of switching between the cells is prevented, it is possible to reduce loss of MBMS data.

### Embodiment 3

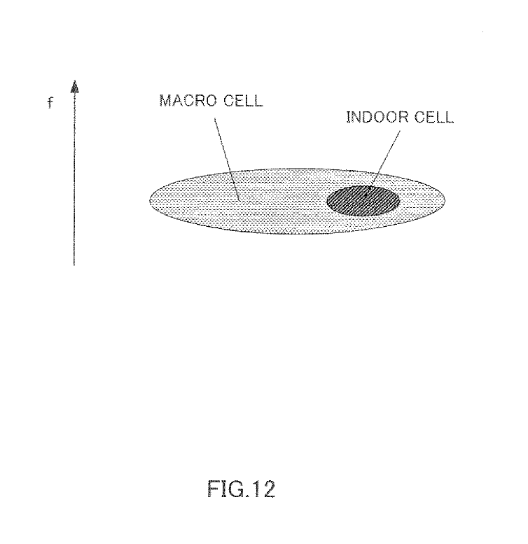

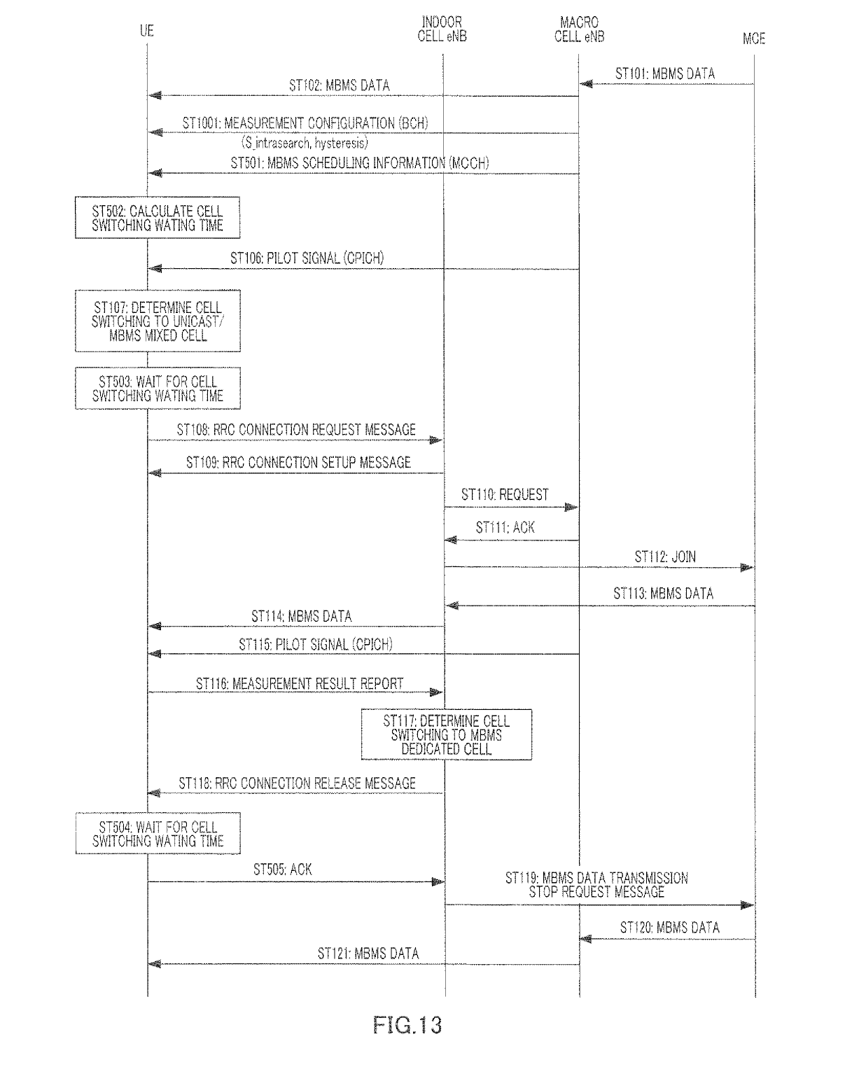

FIG. 12 is a conceptual diagram illustrating an area configuration according to embodiment 3 of the present invention. Here, suppose a unicast/MBMS mixed cell (hereinafter referred to as “macro cell”) and an indoor unicast/MBMS mixed cell having a small cell radius (hereinafter referred to as “indoor cell”) are arranged on the same frequency. Since both the macro cell and the indoor cell are unicast/MBMS mixed cells, both an uplink and a downlink exist. In this case, operations of the UE to switch the serving MBMS cell will be described using FIG. 13.

First, suppose the UE receives an MBMS service from the macro cell using the macro cell as the serving MBMS cell (ST 101 and ST 102). In the present embodiment, since both the macro cell and the indoor cell are unicast/MBMS mixed cells, the UE can camp on both cells.

The UE receives a parameter used for a threshold for switching the serving MBMS cell through system information of the macro cell (ST 1001). In the present embodiment, the UE uses a parameter (S_intrasearch) for performing cell reselection between cells on the same frequency as a first threshold.

Moreover, the UE receives MBMS scheduling information, which is a message indicating a timing at which MBMS data is actually transmitted from the eNB via a multicast control channel (MCCH) (ST501). The UE calculates a cell switching waiting time from the parameter included in the MBMS scheduling information (ST502).

When the reception level of the macro cell is lower than the first threshold, the UE determines to switch the serving MBMS cell to the indoor cell (ST 106 and ST 107). After determining cell switching, the UE waits for a cell switching time (ST503), and then transmits an RRC connection request message including an MBMS service request to the eNB of the indoor cell (ST 108).

The UE establishes an RRC connection with the eNB of the indoor cell and receives an MBMS service from the indoor cell (ST 109 to ST 114). After that, when the reception level of the macro cell is higher than a second threshold (S_intrasearch+hysteresis), the UE transmits a measurement result report to the eNB of the indoor cell and the macro cell transmits an RRC connection release message such that the UE switches the serving MBMS cell from the macro cell to the indoor cell again (ST 115 to ST 118). When receiving the RRC connection release message, the UE waits for the cell switching waiting time (ST504) and then returns a response message (Ack) to the eNB of the indoor cell (ST505).

When receiving the response message from the UE, the eNB of the macro cell sends an MBMS data transmission stop request message to the MCE and the UE receives the MBMS service from the macro cell again (ST 119 to ST 121).

As described above, according to embodiment 3, the parameter used for cell reselection between cells on the same frequency is used as the first threshold as an index for switching the serving MBMS cell to the indoor cell so as to receive a service from the macro cell, so that unnecessary cell switching can be prevented and therefore wasteful consumption of resource can be prevented even when the serving MBMS cell is switched between the unicast/MBMS mixed cells on the same frequency.

Moreover, when switching is performed from the indoor cell to the macro cell again, by using the second threshold resulting from adding an offset value to the first threshold, it is possible to reduce the probability that the UE may return to the macro cell and immediately switch the serving MBMS cell to the indoor cell and therefore suppress an increase in the amount of signaling caused by frequent cell switching.

Here. a new parameter (S_intrambms) may also be set as the first threshold for switching the serving MBMS cell between the cells on the same frequency. This parameter is transmitted through system information of the macro cell.

### Embodiment 4

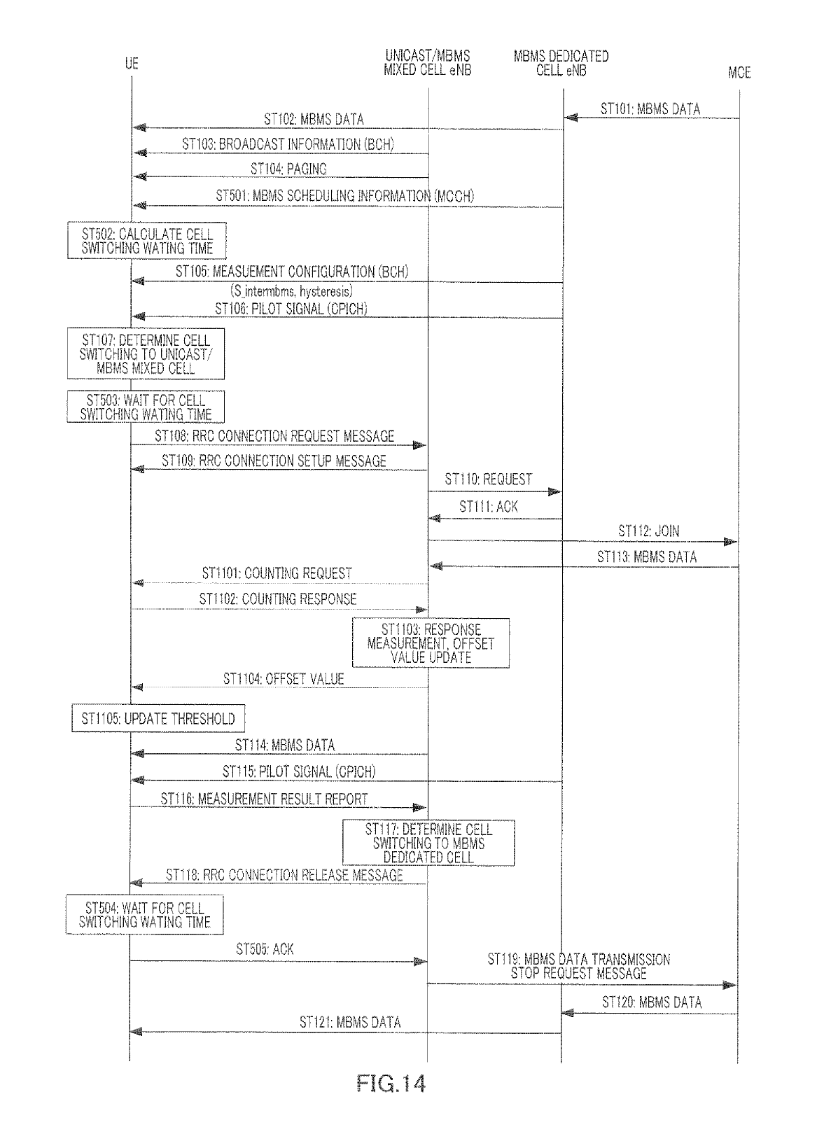

A case will be described where an offset value (hysteresis) is updated according to the number of UEs that temporarily receive MBMS services from the MBMS dedicated cell using the unicast/MBMS mixed cell as the serving MBMS cell. In this ease, operations of the UE and the eNB of the unicast/MBMS mixed cell will be described using FIG. 14. Here, in FIG. 14, the same parts as in FIG. 8 will be assigned the same reference numerals and overlapping descriptions will be omitted.

After an RRC connection between the UE and the eNB of the unicast/MBMS mixed cell is established, the eNB of the unicast/MBMS mixed cell transmits a counting request message to a UE belonging to the unicast/MBMS mixed cell before transmitting MBMS data (ST 1101). The counting request message includes an ID for identifying the corresponding MBMS service. The UE receives the counting request message and returns, when the UE desires to receive the corresponding MBMS service, a counting response message to the eNB of the unicast/MBMS mixed cell (ST 1102). The counting response message includes an MBMS service ID and an ID for identifying the UE.

The eNB of the unicast/MBMS mixed cell receives a counting response from the UE belonging to the unicast/MBMS mixed cell and measures the number of counting responses. The eNB then updates an offset value based on the number of counting responses. To be more specific, when the number of responses is smaller than a predetermined value, the number of responses is updated to an offset value smaller than the offset value previously transmitted and when the number of responses is larger than the predetermined value, the number of responses is not updated (ST 1103). Here, a case where the offset value is updated will be described.

The eNB of the unicast/MBMS mixed cell transmits the updated offset value to the UE (ST 1104) and the UE updates the threshold using the offset value transmitted from the eNB of the unicast/MBMS mixed cell (ST 1105).

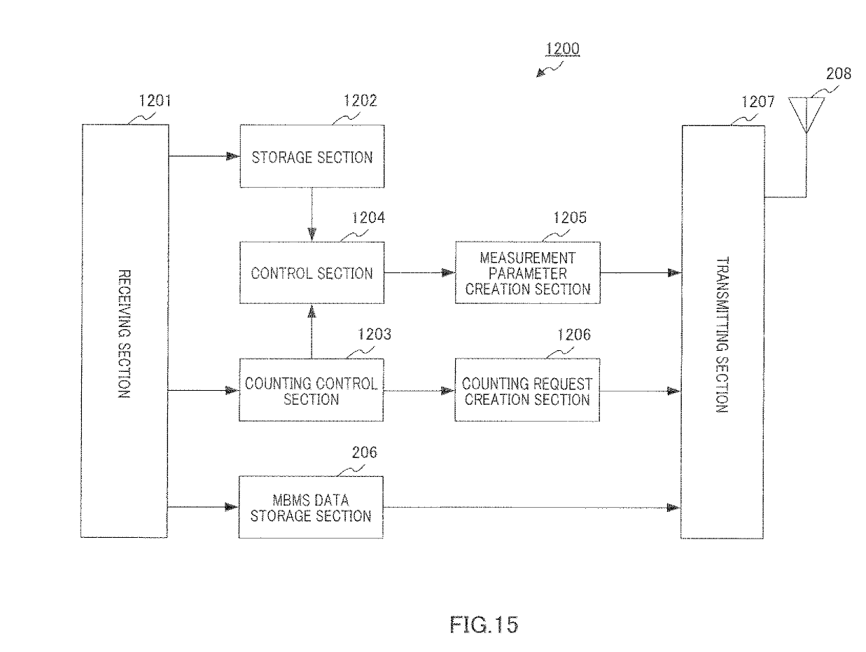

Next, a configuration of eNB 1200 according to embodiment 4 of the present invention will be described using FIG. 15. Receiving section 1201 receives data related to an MBMS service and control information and so forth from the MCE and also receives an MBMS service request and a counting response and so forth from the UE.

Storage section 1202 stores thresholds of the reception level to be references for switching the serving MBMS cell and offset values.

Counting control section 1203 extracts a counting parameter from MBMS-related information inputted from receiving section 1201 and outputs the counting parameter to counting request creation section 1206. Moreover, counting control section 1203 adds up counting responses from the UE and outputs the result to control section 1204.

Control section 1204 outputs the offset value inputted from storage section 1202 to measurement parameter creation section 1205 according to the command inputted from counting control section 1203.

Measurement parameter creation section 1205 creates a message including the measurement parameter inputted from control section 1204 and outputs the message to transmitting section 1207.

Counting request creation section 1206 creates a counting request message including the counting parameter inputted from counting control section 1203 and outputs the counting request message to transmitting section 1207.

Transmitting section 1207 transmits the information inputted from measurement parameter creation section 1205, counting request creation section 1206 and MBMS data storage section 206 from antenna 208.

As described above, according to embodiment 4, when the number of UEs that simultaneously receive the same MBMS service is small, the second threshold is updated to a low value in the UE by updating the offset value to a low value and transmitting the updated offset value from the eNB of the unicast/MBMS mixed cell to the UE, and therefore it is possible to urge the UE to perform switching from the unicast/MBMS mixed cell to the MBMS dedicated cell and thereby reduce resource consumption of the unicast/MBMS mixed cell.

The disclosure of Japanese Patent Application No. 2007-257763, filed on Oct. 1, 2007, including the specification, drawings and abstract is incorporated herein by reference in its entirety.

### INDUSTRIAL APPLICABILITY

The radio transmitting apparatus, radio receiving apparatus, cell switching method and radio communication system according to the present invention can effectively utilize resources of a unicast/MBMS mixed cell, prevent an increase in the amount of signaling accompanying cell switching and are applicable, for example, to a mobile communication system and so forth.

1. A radio transmitting apparatus comprising:
a storage section that stores a first value indicating a reception level of a multimedia broadcast/multicast service dedicated cell to be used as a reference for switching from the MBMS dedicated cell to a unicast/multimedia broadcast/multicast service mixed cell and a second value used for a reference for switching from the unicast/multimedia broadcast/multicast service mixed cell to the multimedia broadcast/multicast service dedicated cell; and
a transmitting section that transmits the first value and the second value as system information.

2. The radio transmitting apparatus according to claim 1, further comprising:
a receiving section that receives a counting response transmitted from a radio communication terminal apparatus in response to a counting request message;
a counting control section that counts the number of the counting responses; and
a control section that controls the second value in accordance with the counted number of the counting responses.

3. A radio receiving apparatus comprising:
a receiving section that receives a first value indicating a reception level of a multimedia broadcast/multicast service dedicated cell used for a reference for switching from the MBMS dedicated cell to a unicast/multimedia broadcast/multicast service mixed cell and a second value used for a reference for switching from the unicast/multimedia broadcast/multicast service mixed cell to the multimedia broadcast/multicast service dedicated cell;
a measuring section that measures a reception level of the MBMS dedicated cell;
a judging section that judges whether or not to perform cell switching based on the measured reception level, the first value and the second value; and
a cell switching control section that performs cell switching control in accordance with the judgment result.

4. The radio receiving apparatus according to claim 3, further comprising a calculation section that calculates a waiting time until cell switching is started based on scheduling information when cell switching is judged to be performed,
wherein the cell switching control section waits for the calculated waiting time and performs the cell switching control.

5. A cell switching method comprising the steps of:
measuring a reception level of an MBMS dedicated cell;
performing threshold judgment on the measured reception level with a first value and a second value greater than the first value, judging, when the reception level is lower than the first value, that switching is to be performed from the multimedia broadcast/multicast service dedicated cell to the unicast/multimedia broadcast/multicast service mixed cell and judging, when the reception level is higher than the second value, that switching is to be performed from the unicast/multimedia broadcast/multicast service mixed cell to the multimedia broadcast/multicast service dedicated cell; and
performing cell switching control in accordance with the judgment result.

6. A radio communication system comprising:
a unicast/multimedia broadcast/multicast service mixed cell radio communication base station apparatus comprising:
a receiving section that receives a service request from a radio communication terminal apparatus; and
a transmitting section that transmits system information and paging and transmits MBMS data in response to the service request,
a multimedia broadcast/multicast service dedicated cell radio communication base station apparatus comprising:
a storage section that stores a first value indicating a reception level of a multimedia broadcast/multicast service dedicated cell used for a reference for switching from the MBMS dedicated cell to a unicast/multimedia broadcast/multicast service mixed cell and a second value used for a reference for switching from the unicast/multimedia broadcast/multicast service mixed cell to the multimedia broadcast/multicast service dedicated cell; and
a transmitting section that transmits the first value and the second value as system information,
a radio communication terminal apparatus comprising:
a receiving section that receives the first value and the second value transmitted from the multimedia broadcast/multicast service dedicated cell radio communication base station apparatus;
a measuring section that measures the reception level of the multimedia broadcast/multicast service dedicated cell,
a judging section that judges whether or not to perform cell switching based on the measured reception level, the first value and the second value; and
a cell switching control section that performs cell switching control in accordance with the judgment result.
